(19) United States
(12) Patent Application Publication
(10) Pub. No.: US 2012/0173425 A1
(43) Pub. Date: Jul. 5, 2012

(54) MOBILE DEVICE AND METHOD FOR PROVIDING SECURITY FUNCTION

(75) Inventor: Hyun Doo JEONG, Incheon (KR)

(73) Assignee: SAMSUNG ELECTRONICS CO. LTD., Suwon-si (KR)

(21) Appl. No.: 13/337,582

(22) Filed: Dec. 27, 2011

(30) Foreign Application Priority Data
Jan. 3, 2011 (KR) 10-2011-0000101

(51) Int. Cl. G06F 21/00; G06Q 20/32; G06Q 20/40

(52) U.S. Cl. 705/44; 726/5; 726/3

(57) ABSTRACT

A mobile device and a method for enhancing a security function through a password combination by using posture-based passwords as well as number-based passwords are provided. In the method, the mobile device receives its posture information when one of predefined security events is selected, and compares the received posture information with predefined security information. If the received posture information is identical to the predefined security information, the mobile device performs a particular function of the selected security event.

### PRIORITY

This application claims the benefit under 35 U.S.C. §119(a) of a Korean patent application filed on Jan. 3, 2011 in the Korean Intellectual Property Office and assigned Serial No. 10-2011-0000101, the entire disclosure of which is hereby incorporated by reference.

### BACKGROUND OF THE INVENTION

1. Field of the Invention

The present invention relates to a security technology of a mobile device. More particularly, the present invention relates to a mobile device and a method for enhancing a security function through a password combination by using posture-based passwords as well as number-based passwords.

2. Description of the Related Art

With the remarkable growth of related technologies, a great variety of mobile devices, such as a mobile communication device, a Personal Digital Assistant (PDA), an electronic scheduler, a smart phone, and a tablet Personal Computer (PC) have been increasingly popularized. Mobile devices today have various additional functions for user's convenience, such as a scheduler function, a memo function, a phonebook function, a call history function, a message log function, a digital camera function, a short range wireless communication function (e.g., a Near Field Communication (NFC) function), a mobile payment function, and the like.

When the above-mentioned additional functions are used, a mobile device may store related personal information, such as a call history record (e.g., a list of received calls, a list of sent calls, a list of missed calls, a list of sent messages, a list of received messages, etc.), schedule data, photo data, video data, sent or received message contents, and financial information related to a mobile payment function.

This personal information stored in the mobile device may be easily exposed to other persons. Therefore, in order to restrict unauthorized access, a mobile device usually provides a security function based on a password. A typical security function of a mobile device is based on a combination of numeric data. When a user enters numbers as a password, a mobile device releases a security state (i.e., a lock state) and allows access only when a password input is identical to a predefined password.

However, a security function based on a numeric password has a restriction based on the number of combinations available for a password due to limited password digits. Therefore, this security function based on insufficient combinations of numeric passwords may be incapacitated or hacked, so that damage may be caused by the leakage of personal information. Moreover, a user of a mobile device that supports a mobile payment service may be faced with serious problems due to unauthorized use by others.

Therefore, a need exists for a mobile device and a method for enhancing a security function through a password combination by using posture-based passwords as well as number-based passwords.

### SUMMARY OF THE INVENTION

Aspects of the present invention are to address at least the above-mentioned problems and/or disadvantages and to provide at least the advantages described below. Accordingly, an aspect of the present invention is to provide an advanced security function using posture variations of a mobile device.

Another aspect of the present invention is to allow any security event to be executed in response to an input of a proper password based on posture information of a mobile device.

Still another aspect of the present invention is to provide a methodology for setting a password through posture information of a mobile device as well as numeric information.

Yet another aspect of the present invention is to enhance the security of a mobile device that supports a short range wireless communication.

Yet another aspect of the present invention is to provide an optimal environment for enhancing a security function of a mobile device.

According to an aspect of the present invention, a method for providing a security function of a mobile device is provided. The method includes receiving posture information of the mobile device when one of predefined security events is selected, comparing the received posture information with predefined security information, and when the received posture information is identical to the predefined security information, performing a particular function of the selected security event.

According to another aspect of the present invention, a method for providing a security function of a mobile device is provided. The method includes receiving a password input based on posture information of the mobile device when a mobile payment function is requested, comparing the posture information received as the password input with predefined security information, and when the received posture information is identical to the predefined security information, performing the mobile payment function.

According to another aspect of the present invention, a mobile device is provided. The mobile device includes a sensor unit for detecting variations in a posture of the mobile device, a memory unit for storing predefined security information, and a control unit for activating the sensor unit in response to a request for a security event, for performing user authentication using posture information based on the posture variations detected by the sensor unit, and for performing a particular function of the security event.

According to various aspects of the present invention, a mobile device may use various password types based on posture information obtained from posture variations of the mobile device as well as based on numeric information. Additionally, a password using posture information, a password using a combination of posture information and numeric information, and a password based on posture information for each function are possible. This may increase the number of possible password combinations and therefore enhance a security function of the mobile device.

Moreover, according to a specific aspect of the present invention, the mobile device may execute any billing-related security event (e.g., a mobile payment service using a Near Field Communication (NFC) technology) after user authentication based on posture information. This may enhance a security function of the mobile device and also may promote usability of such security events. Namely, conventional password techniques using numeric information alone may be undesirable to any security event requiring rapid processing since it may cause a time loss and errors in entering a numeric password. In contrast, an exemplary embodiment of the present invention may rapidly release a lock state and immediately perform a function of a desired security event by simply changing a posture of the mobile device.

Techniques disclosed herein may be favorably and widely applied to any kind of mobile device and also may offer an optimal environment for enhancing a security function of any kind of mobile device. Such techniques may promote usability, accessibility and competitiveness of a mobile device.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating a configuration of a mobile device having a security function in accordance with an exemplary embodiment of the present invention.

FIG. 2 is a schematic view illustrating a process of a security function based on posture information of a mobile device in accordance with an exemplary embodiment of the present invention.

FIG. 3 is a schematic view illustrating a detection of posture information by a mobile device in accordance with an exemplary embodiment of the present invention.

FIG. 4 is a flow diagram illustrating a method for providing a security function of a mobile device in accordance with an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to their bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention proposed herein relate to a mobile device having an enhanced security function and a method for providing an enhanced security function for a mobile device. According to an exemplary embodiment of the present invention, a security function of a mobile device may be based on a password using posture information of a mobile device. Alternatively or additionally, a security function of a mobile device may rely on a password combination by using various combinations of posture information of a mobile device and numeric information. Furthermore, when any security event that requires a password input occurs, exemplary embodiments of the present invention offer a suitable interface environment for entering a password based on a combination of posture information and numeric information.

According to exemplary embodiments of the present invention, it is possible to establish a posture-based security function for each individual function of a mobile device. Therefore, a mobile device may allow a particular function of a requested security event to be executed in response to user authentication that uses a password input based on posture information of a mobile device.

A mobile device and its operation according to an exemplary embodiment of the present invention will be described with reference to the drawings. The embodiments set forth hereinafter are, however, merely exemplary and their use and definition in no way limit the scope of the invention. As will be understood by persons skilled in the art, any other alternative embodiments may be favorably used.

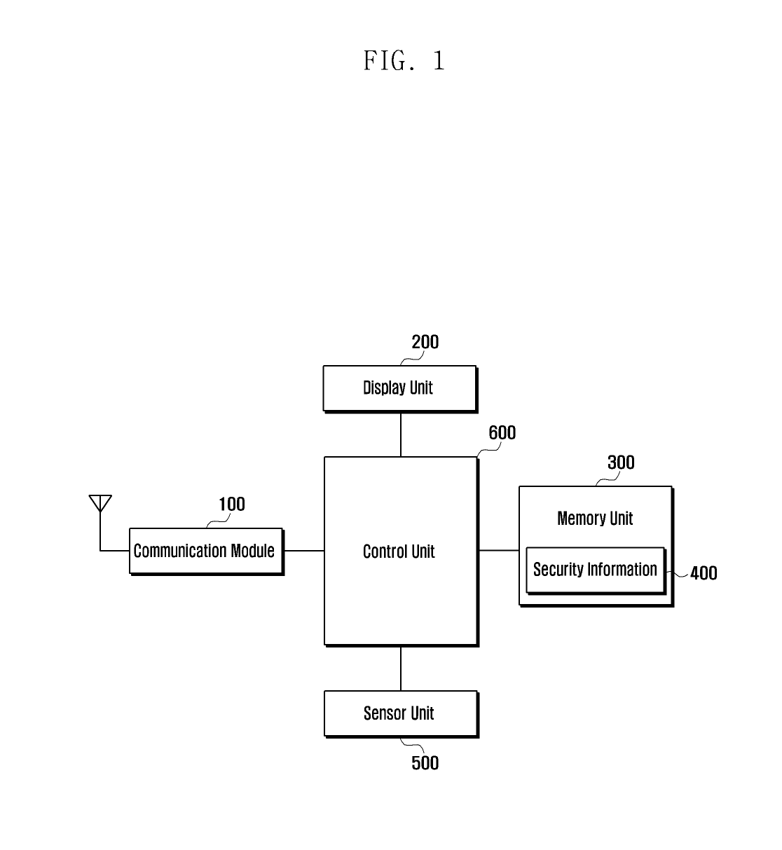

FIGS. 1 through 4, discussed below, and the various exemplary embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the invention. Terms first, second, and the like are used to differentiate between objects having the same terminology and are in no way intended to represent a chronological order, unless where explicitly stated otherwise. A set is defined as a non-empty set including at least one element.

FIG. 1 is a block diagram illustrating a configuration of a mobile device having a security function in accordance with an exemplary embodiment of the present invention.

Referring to FIG. 1, a mobile device includes a communication module 100, a display unit 200, a memory unit 300, a sensor unit 500, and a control unit 600. Additionally, the mobile device may include an audio processing unit having a microphone and a speaker, a digital broadcast module for receiving and playing digital broadcasting, such as Digital Multimedia Broadcasting (DMB) or Digital Video Broadcasting (DVB), a camera module for taking a photo or recording a video, a Bluetooth communication module for performing a Bluetooth communication function, an Internet communication module for performing an Internet communication function, a touch pad for a touch-based input, a key input unit for a mechanical key input, a battery for supplying power to such elements, and the like. Since these elements are well known in the art, related illustration and description will be omitted herein.

The communication module 100 is to support a specific communication service, such as a mobile communication service, an Internet service (e.g., a Wireless-Fidelity (Wi-Fi) service) based on a Wireless Local Area Network (WLAN), or a short range wireless communication service (e.g., a Near Field Communication (NFC) service). The communication module 100 may form a communication channel with any external server or any other device and may transmit or receive data through the channel. In an exemplary implementation, the communication module 100 supports NFC based communication technology.

NFC technology is a short range communication technology that allows data communication between devices within a distance of about 10 cm by using a frequency band of 13.56 MHz. Contrary to existing Radio Frequency Identification (RFID) technology that allows only reading, NFC technology allows a bidirectional transmission of data and is, therefore, capable of both reading and writing. Additionally, NFC technology has a more enhanced security function than RFID technology and attracts attention especially in the field of mobile payment. Furthermore, NFC technology can read various types of information and allows a Peer-to-Peer (P2P) network communication between devices. Therefore, NFC technology may be applied to wide fields including various applications of a smart phone, a Location Based Service (LBS) or its applications, book rental, parking location information, card balance inquiry, read and record of coupons or tickets, and the like.

The display unit 200 displays data or information in connection with the operation or state of the mobile device. For instance, the display unit 200 may display various execution screens of applications or functions supported in the mobile device, including a home screen, a message service, an e-mail, Internet, a search function, a communication function, an e-book, a video play function, a camera function, an image viewer, a broadcasting function, a music function, a game function, etc. The display unit 200 may be formed of a Liquid Crystal Display (LCD) or any other equivalent, such as Organic Light Emitting Diodes (OLEDs) or Active Matrix OLEDs (AMOLEDs). Additionally, when displaying the above execution screens, the display unit 200 may provide a landscape mode (i.e., a horizontal mode) or a portrait mode (i.e., a vertical mode), depending on the direction of the mobile device.

Furthermore, the display unit 200 may have a touch-sensitive interface that supports a touch-based input. For instance, the display unit 200 may receive a touch-based user input through a touch screen, create a resultant input signal, and send the input signal to the control unit 600.

The memory unit 300 stores a variety of programs and related data that are executed and processed in the mobile device, and may include at least one nonvolatile memory and a volatile memory. The nonvolatile memory may correspond to a Read Only Memory (ROM), a flash memory, or the like, and the volatile memory may correspond to a Random Access Memory (RAM), or the like. The memory unit 300 may continuously or temporarily store the operating system of the mobile device, programs and data related to a display control of the display unit 200, programs and data related to an input control through the display unit 200, programs and data related to a security function control of the mobile device, and the like.

In an exemplary embodiment of the present invention, the memory unit 300 may store security information 400 to be used for the execution of a security function. This security information 400 may include a password, which is predefined by a user's definition, and security event information. A password may be established using posture information, which depends on posture variations of the mobile device, or a combination of posture information and numeric information. Security event information is any information about any security event (e.g., the execution of a particular function or application) that requires an input of a proper password. For instance, when there is a request for the execution of an NFC-based mobile payment function, the control unit 600 may refer to security event information in the security information 400, recognize that a mobile payment function is one of security events, and request a user to enter a password in order to execute the mobile payment function. The control unit 600 may receive a password input (e.g., an input of posture information or a combination input of posture information and numeric information) from a user and compare the password input with a predefined password in order to determine the execution or not. The memory unit 300 may temporarily store a password (e.g., posture information obtained from posture variations of the mobile device) inputted while a security function is activated.

The sensor unit 500 may detect variations in posture of the mobile device and deliver corresponding electric signals to the control unit 600. More particularly, the sensor unit 500 may measure posture variations of the mobile device when the control unit 600 detects any security event. Alternatively, the sensor unit 500 may always operate and continuously detect posture variations of the mobile device even though this may cause high power consumption and overload. An exemplary embodiment set forth herein is the case where posture information is registered in advance in the security information 400 and where the sensor unit 500 starts operating in response to detection of any security event.

In an exemplary embodiment of the present invention, the sensor unit 500 may include at least one detecting device selected from all kinds of detecting devices that can detect variations in posture of the mobile device. For instance, the sensor unit 500 may include at least one of an acceleration sensor and a gyro sensor.

The control unit 600 controls operations of the mobile device. More particularly, the control unit 600 may control operations related to a security function of the present invention. More specifically, the control unit 600 may support a password setup using posture information of the mobile device, a password setup using numeric information, and a password setup using a combination of posture information and numeric information. In addition, when any security event defined in the security information 400 occurs, the control unit 600 may receive a password input and compare the received password input with a specific password defined in the security information 400. Furthermore, the control unit 600 may determine whether to execute a particular function of the security event, depending on the result of the comparison. Namely, the control unit 600 may control the execution of a function of the security event when the received password input is identical to the predefined password, and control the output of an error message or equivalents when the received password input is not identical to the predefined password.

In an exemplary embodiment of the present invention, the control unit 600 may approve a password by comparing posture information received from the sensor unit 500 with predefined security information 400. In this case, the control unit 600 may perform a password approval through an en bloc comparison or a sequential comparison. The en bloc comparison is to collect all pieces of posture information from posture variations of the mobile device and to compare the entire posture information with the security information. The sequential comparison is to compare posture information with the security information whenever the posture information is inputted.

The above-discussed control operations of the control unit 600 will be described below in more detail.

The control unit 600 performs a variety of control operations in connection with normal functions of the mobile device. For instance, the control unit 600 may control the execution of a selected application and the display of related data. Furthermore, the control unit 600 may receive input signals corresponding to various input forms supported by a touch-based input interface and control corresponding functions. In addition, the control unit 600 may control data transmission and reception based on a wired or wireless communication.

Meanwhile, the mobile device shown in FIG. 1 may be applied to all device types, such as a bar type, a folder type, a slide type, a swing type, a flip type, etc. Additionally, the mobile device may include any of communication devices, multimedia players and their application equipment. For instance, the mobile device may include various mobile communication terminals based on various communication protocols, a tablet Personal Computer (PC), a smart phone, a Portable Multimedia Player (PMP), a digital broadcasting player, a Personal Digital Assistant (PDA), a portable game console, etc.

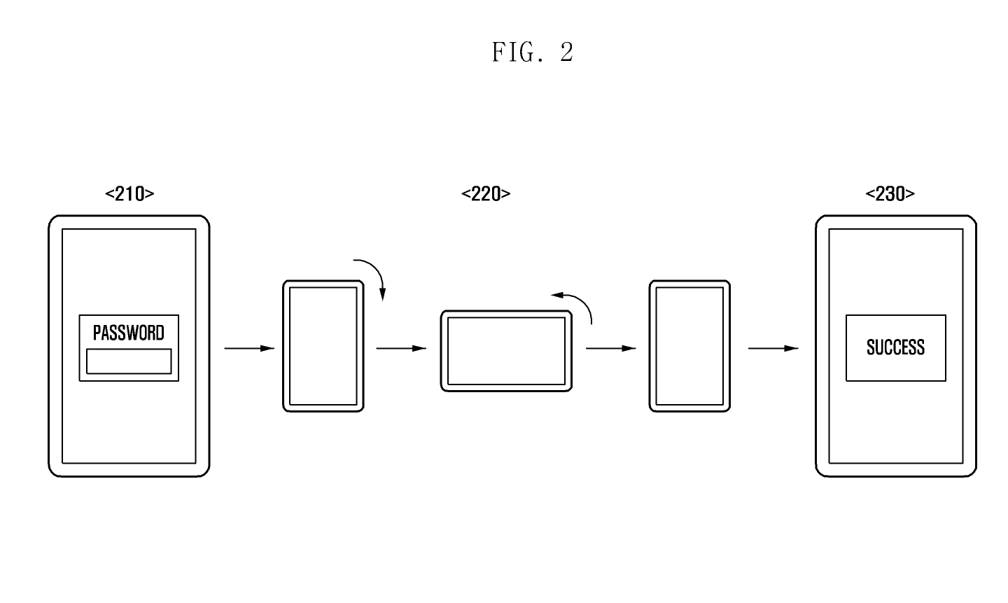

FIG. 2 is a schematic view illustrating a process of a security function based on posture information of a mobile device in accordance with an exemplary embodiment of the present invention.

Although FIG. 2 illustrates a process of a security function using posture information obtained from variations in posture of the mobile device, the process of a security function may use numeric information alone or a combination of posture information and numeric information.

Referring to FIG. 2, as indicated by reference number 210, data (e.g., a screen for a password input) is displayed in response to the occurrence of any security event. More specifically, when a user performs a manipulation for a desired security event, such as a release of a lock state of the mobile device, an activation of an NFC-based mobile payment function, a setup for a password, etc., the mobile device 600 may provide a screen for receiving a password input as indicated by the reference number 210.

A user may take an action of a password input. Namely, a user may change the posture of the mobile device in a predefined pattern so as to enter a password input. For instance, as indicated by a reference number 220, a user may turn the mobile device to the right (e.g., a positive rotation of 90 degrees from a longitudinal direction to a cross direction) and turn the mobile device to the left (e.g., a negative rotation of 90 degrees from a cross direction to a longitudinal direction).

The control unit 600 may obtain posture information from variations in the posture of the mobile device and compare the posture information with a predefined password in the security information 400. As discussed above, this comparison may be an en bloc comparison which collects all pieces of posture information corresponding to user's inputs and compares the entire posture information with the security information, or a sequential comparison which compares posture information with the security information whenever the posture information is inputted.

If the posture information is identical to the predefined password, the control unit 600 may inform a user about a success in password approval as indicated by a reference number 230, or perform a particular function of the security event.

Meanwhile, in the process of a security function shown in FIG. 2, a user may set or redefine a password, using a combination of posture information and numeric information as well as using posture information alone. For instance, a password based on posture information alone may be set as “posture information 1, posture information 2, and posture information 3”. A password based on a combination of posture information and numeric information may be set as “posture information 1, numeric information 1, posture information 2, and numeric information 2”, or “posture information 1, posture information 2, numeric information 1, and numeric information 2”. After performing a manipulation for a desired security event, such as a release of a lock state of the mobile device or an activation of an NFC-based mobile payment function, a user may enter a password input in the above pattern.

In an exemplary implementation, the mobile device may not output any display data as indicated by the reference number 210 in response to the occurrence of any security event and may directly receive a password input based on posture information. No screen for a password input may prevent another person from using a mobile payment function. This option may be defined by a user's setting. More specifically, even though a mobile payment function is requested, the control unit 600 may not provide a password input screen as indicated by the reference number 210 and may wait for an input of posture information. Therefore, while a user can easily take an action for a password input by changing the posture of the mobile device, other persons may not know a state for receiving a password input due to no appearance of a password input screen. Accordingly, even in a case of the loss of the mobile device, improper use of a mobile payment function may be prevented.

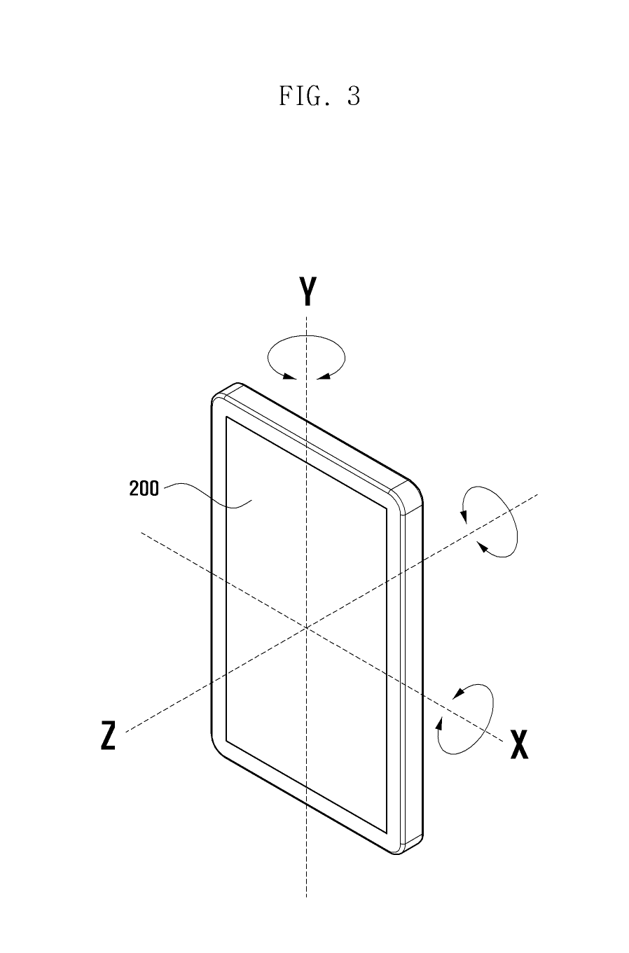

FIG. 3 is a schematic view illustrating a detection of posture information by a mobile device in accordance with an exemplary embodiment of the present invention.

As shown in FIG. 3, a surface where the display unit 200 of the mobile device is located is defined as a main side. A basic state is defined from a state where the main side faces frontward and the mobile device is in a longitudinal direction. This is, however, merely exemplary and its use and definition in no way limits the scope of the invention. Alternatively, any other state may be defined as a basic state, such as a state where the main side faces frontward and the mobile device is in a cross direction, a state where the main side faces upward and the mobile device is in a longitudinal direction, or a state where the main side faces upward and the mobile device is in a cross direction. The basic state may be set as the default by the manufacturer or redefined by a user's setting. Herein, a state where the main side faces frontward and the mobile device is in a longitudinal direction will be used as a basic state.

Referring to FIG. 3, in a basic state, the mobile device may obtain posture information from detected posture variations on the Z-axis, such as a positive rotation on the Z-axis (i.e., a clockwise rotation of given angles on the Z-axis) or a negative rotation on the Z-axis (i.e., a counterclockwise rotation of given angles on the Z-axis). Many posture variations are possible, such as positive rotations of 45 degrees, 90 degrees, 135 degrees, 180 degrees, or the like on the Z-axis, negative rotations of 45 degrees, 90 degrees, 135 degrees, 180 degrees, or the like on the Z-axis, or alternate rotations of positive and negative rotations on the Z-axis (e.g., a sequence of a positive rotation, a negative rotation, and a positive rotation).

Similarly, in a basic state, the mobile device may obtain posture information from detected posture variations on the X-axis, such as a positive rotation on the X-axis (i.e., a clockwise rotation of given angles on the X-axis) or a negative rotation on the X-axis (i.e., a counterclockwise rotation of given angles on the X-axis). Many posture variations are possible, such as positive rotations of 45 degrees, 90 degrees, 135 degrees, 180 degrees, or the like on the X-axis, negative rotations of 45 degrees, 90 degrees, 135 degrees, 180 degrees, or the like on the X-axis, or alternate rotations of positive and negative rotations on the X-axis.

Similarly, in a basic state, the mobile device may obtain posture information from detected posture variations on the Y-axis, such as a positive rotation on the Y-axis (i.e., a clockwise rotation of given angles on the Y-axis) or a negative rotation on the Y-axis (i.e., a counterclockwise rotation of given angles on the Y-axis). Many posture variations are possible, such as positive rotations of 45 degrees, 90 degrees, 135 degrees, 180 degrees, or the like on the Y-axis, negative rotations of 45 degrees, 90 degrees, 135 degrees, 180 degrees, or the like on the Y-axis, or alternate rotations of positive and negative rotations on the Y-axis.

Moreover, in a basic state, the mobile device may obtain posture information from detected posture variations on at least two axes of the X-axis, the Y-axis, and the Z-axis. One example of such posture variations is a combination of a negative rotation of 90 degrees on the X-axis, a negative rotation of 90 degrees on the Y-axis, and a positive rotation of 90 degrees on the Z-axis. Posture information based on posture variations on at least two axes will further increase the number of cases for a password combination and therefore enhance a security function of the mobile device.

As discussed above, the mobile device may obtain, in a basic state, posture information from detected posture variations on at least one of the X-axis, the Y-axis, and the Z-axis.

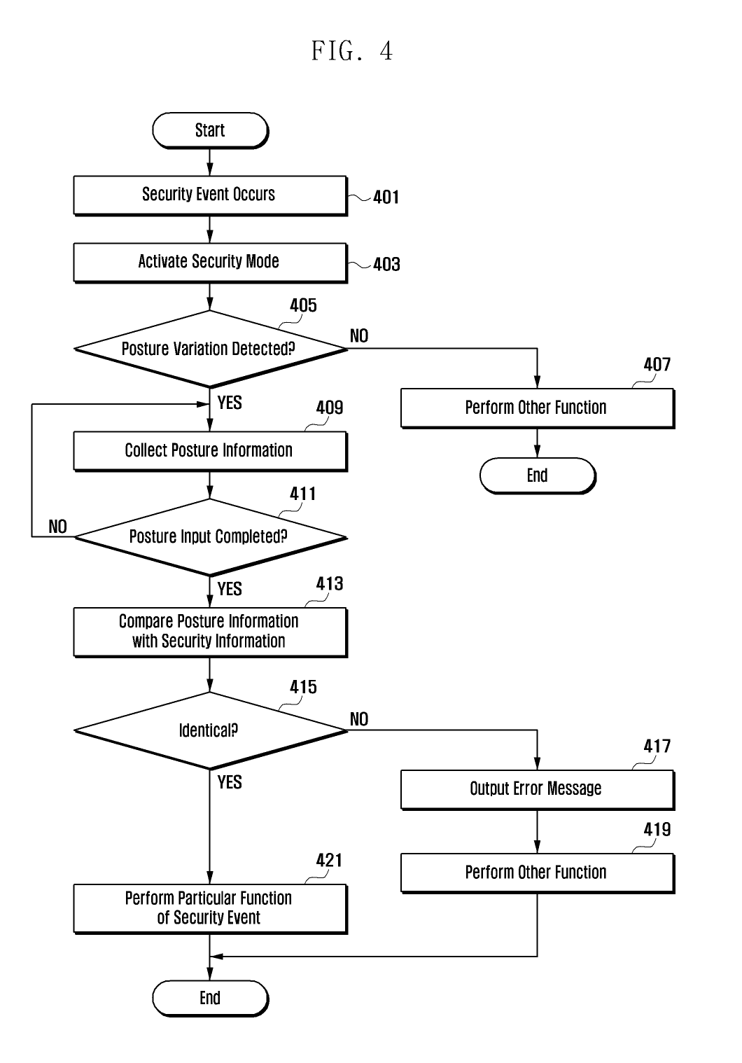

FIG. 4 is a flow diagram illustrating a method for providing a security function of a mobile device in accordance with an exemplary embodiment of the present invention.

Referring to FIG. 4, a control unit 600 may detect the occurrence of any security event in step 401. More specifically, a user may request a desired security event, such as a release of a locked state of the mobile device, an activation of an NFC-based mobile payment function, a setup for a password, etc. The mobile device 600 may then refer to the security event information defined in the security information 400 and determine whether the requested event is one of defined security events. If so, the control unit 600 may recognize that any security event occurs, namely that the execution of any security event is requested.

The control unit 600 may activate a security mode in step 403. The activation of a security mode may include displaying a screen for a password input as indicated by the reference number 210 in FIG. 2 in response to the occurrence of any security event. However, displaying of a password input screen may be omitted depending on types of security event.

In the security mode, the control unit 600 may determine whether posture variations are detected in step 405. More specifically, the control unit 600 may activate the sensor unit 500 as discussed above and may determine whether electrical signals corresponding to posture variations are received from the sensor unit 500.

If no posture variation is detected (i.e., in a case of a no branch of the step 405), the control unit 600 may perform any other predefined function in step 407. For instance, if no posture variation is detected for a given time, the control unit 600 may output an error message. In addition, while keeping a locked state, the control unit 600 may inactivate the security mode.

If any posture variation is detected (i.e., in a case of a yes branch of the step 405), the control unit 600 may collect posture information in step 409. More specifically, the control unit 600 may collect at least one electrical signal that corresponds to the posture variation detected by and received from the sensor unit 500.

The control unit 600 may determine whether an input of posture information is completed in step 411. More specifically, when any succeeding posture information is not received for a given time or when any input signal for indicating the completion of a password input is received from a user, the control unit 600 may determine that an input of posture information is completed. In an exemplary implementation, a user may change the posture of the mobile device with a specific function key pressed so as to enter a password input based on posture information. In this case, the control unit 600 may activate the sensor unit 500 in response to the press of the specific function key. Therefore, the completion of a password input may include a release of the specific function key.

If an input of posture information is not yet completed (i.e., in a case of a no branch of the step 411), the control unit 600 may return to the step 409 and continue to collect posture information. If an input of posture information is completed (i.e., in a case of a yes branch of the step 411), the control unit 600 may compare the collected posture information with predefined security information in step 413 and determine whether the collected posture information is identical to the predefined security information in step 415.

If the collected posture information is not identical to the predefined security information (i.e., in a case of a no branch of the step 415), the control unit 600 may notify an error in step 417 and perform any other predefined function in step 419. For instance, the control unit 600 may output an error message that shows an incorrect password input, and may request a password input again or complete the process.

If the collected posture information is identical to the predefined security information (i.e., in a case of a yes branch of the step 415), the control unit 600 may perform a particular function of the security event in step 421. In a case where the security event is a release of a lock state of the mobile device, the control unit 600 may release the lock state of the mobile device and also control a display of related screen data. In a case where the security event is an activation of an NFC-based mobile payment function, the control unit 600 may execute the NFC-based mobile payment function and also control operations for the mobile payment function (e.g., signal transmission through the communication module 100 in connection with a payment service).

As shown in steps 409 through 413, the control unit 600 in this exemplary embodiment performs an en bloc comparison in which all pieces of posture information are collected and compared with the security information. For instance, when posture information 1, posture information 2, and posture information 3 are inputted in turn, the control unit 600 collects all of posture information 1, posture information 2, and posture information 3 and simultaneously compares them with posture information A, posture information B, and posture information C stored in the security information.

However, according to another exemplary embodiment, the control unit 600 may perform a sequential comparison in which posture information is compared with the security information whenever inputted. For instance, when posture information 1 is inputted, the control unit 600 compares posture information 1 with posture information A stored as the first password in the security information, and when posture information 2 is inputted, the control unit 600 compares posture information 2 with posture information B stored as the second password in the security information. In a case of the sequential comparison, the control unit may immediately output an error message when any posture information is not identical to the predefined password.

Although not illustrated in FIG. 4, a posture-based password may be established for each individual function or application of the mobile device. In a case of an NFC-based mobile payment function, the activation of a security mode may depend on a specific function key and a password using posture information as discussed above. In this case, a user can rapidly release a locked state and immediately perform the mobile payment function by pressing the specific key and also simply changing a posture of the mobile device. This may enhance a security function of the mobile device and also may promote usability of such security events.

The above-described methods according to exemplary embodiments of the present invention can be realized in hardware or as software or computer code that can be stored in a recording medium, such as a Compact Disc Read Only Memory (CD ROM), a Random Access Memory (RAM), a floppy disk, a hard disk, or a magneto-optical disk or downloaded over a network, so that the methods described herein can be rendered in such software using a computer, or a special processor or in programmable or dedicated hardware, such as an Application Specific Integrated Circuit (ASIC) or a Field Programmable Gate Array (FPGA). As would be understood in the art, the computer, the processor or the programmable hardware include memory components, e.g., a RAM, a ROM, a Flash memory, etc. that may store or receive software or computer code that when accessed and executed by the computer, processor or hardware implement the processing methods described herein. In addition, it would be recognized that when a computer accesses code for implementing the processing shown herein, the execution of the code transforms the computer into a special purpose computer for executing the processing shown herein.

While this invention has been shown and described with reference to certain exemplary embodiment thereof, it will be understood by those skilled in the art that various changes in form and details may be made therein without departing from the spirit and scope of the invention as defined by the appended claims and their equivalents.

What is claimed is:

1. A method for providing a security function of a mobile device, the method comprising:
receiving posture information of the mobile device when one of predefined security events is selected;
comparing the received posture information with predefined security information; and
when the received posture information is identical to the predefined security information, performing a particular function of the selected security event.

2. The method of claim 1, wherein the receiving of the posture information includes collecting the posture information detected from variations in a posture of the mobile device.

3. The method of claim 2, wherein the comparing of the received posture information includes performing an en bloc comparison to compare the entire posture information with all passwords stored in the predefined security information.

4. The method of claim 1, wherein the comparing of the received posture information includes performing a sequential comparison to compare the posture information with each password stored in the predefined security information whenever the posture information is inputted.

5. The method of claim 1, further comprising:
receiving a user's request for any security event;
determining whether the requested event is one of the security events defined in security event information; and
if the requested event is one of the security events, recognizing that the predefined security event is selected.

6. The method of claim 5, wherein the receiving of the posture information includes:
activating a sensor unit for detecting variations in a posture of the mobile device when recognizing a selection of the security event; and
receiving the posture information based on the posture variations from the sensor unit.

7. The method of claim 1, further comprising:
setting a password of the mobile device from the posture information based on variations in a posture of the mobile device.

8. The method of claim 7, further comprising:
setting the password of the mobile device from a combination of the posture information and numeric information.

9. The method of claim 1, wherein the posture information is obtained in a predefined basic state from posture variations detected on at least one of an X-axis, a Y-axis, and a Z-axis of the mobile device.

10. A method for providing a security function of a mobile device, the method comprising:
receiving a password input based on posture information of the mobile device when a mobile payment function is requested;
comparing the posture information received as the password input with predefined security information; and
when the received posture information is identical to the predefined security information, performing the mobile payment function.

11. The method of claim 10, further comprising:
activating a sensor unit for detecting variations in a posture of the mobile device when the mobile payment function is requested; and
obtaining the posture information from the posture variations through the sensor unit.

12. The method of claim 10, further comprising:
receiving a press input from a specific function key of the mobile device when the mobile payment function is requested;
activating a sensor unit for detecting variations in a posture of the mobile device when the press input is received from the specific function key; and
obtaining the posture information from the posture variations through the sensor unit while the press input is received from the specific function key.

13. The method of claim 10, wherein the receiving of the password further comprises receiving a combination of the posture information and numeric information.

14. A mobile device comprising:
a sensor unit for detecting variations in a posture of the mobile device;
a memory unit for storing predefined security information; and
a control unit for activating the sensor unit in response to a request for a security event, for performing user authentication based on posture information obtained from posture variations detected by the sensor unit, and for performing a particular function of the security event.

15. The device of claim 14, wherein the sensor unit includes at least one of an acceleration sensor and a gyro sensor.

16. The device of claim 14, wherein the control unit performs the user authentication by comparing the posture information with the security information.

17. The device of claim 16, wherein the control unit performs the user authentication through at least one of:
an en bloc comparison in which the entire posture information is collected and compared with the security information, and
a sequential comparison in which the posture information is compared with the security information whenever the posture information is inputted.

18. The device of claim 14, further comprising:
a communication module configured for a mobile payment function based on a short range wireless communication.

19. The device of claim 14, further comprising an input unit for receiving numeric information, wherein the control unit performs the user authentication based on the posture information and the numeric information.
